(19) United States
(12) Patent Application Publication
(10) Pub. No.: US 2023/0052901 A1
(43) Pub. Date: Feb. 16, 2023

(54) METHOD AND SYSTEM FOR POINT OF SALE PAYMENT USING A MOBILE DEVICE

(71) Applicant: Lunchbox Technologies Inc., New York, NY (US)

(72) Inventors: Andrew Christopher Boryk, New York, NY (US); Nabeel Alamgir, New York, NY (US); Randall Griffith Huynh, New York, NY (US); Mohammad Shahid Afzal, New York, NY (US); Mikhail Foenko, New York, NY (US); Yvan Venturina Pangilinan, Edgewater, NJ (US)

(21) Appl. No.: 17/400,532

(22) Filed: Aug. 12, 2021

(51) Int. Cl. G06Q 20/20; G06Q 20/32; G06Q 20/38; G06Q 20/02; G06Q 20/40; G06Q 40/02; H04L 9/32

(52) U.S. Cl. CPC G06Q 20/202; G06Q 20/326; G06Q 20/385; G06Q 20/02; G06Q 20/204; G06Q 20/3227; G06Q 20/3224; G06Q 20/4037; G06Q 40/02; G06Q 20/208; G06Q 20/3274; G06Q 20/3278; H04L 9/3239; G06Q 20/28

(57) ABSTRACT

To conduct a payment transaction at a merchant's point of sale using a mobile device, the mobile device initiates an authenticated communication session with a payment agent. The payment agent is an entity responsible for facilitating a payment transaction between the merchant and purchaser via their respective financial institutions. During the authenticated communication session, response to an input indicating the user of the mobile device wishes to make a payment, the mobile device generates a unique payment key that is based on at least one unique data of the mobile device. The mobile device transmits the payment key to the payment agent, and then transfers a copy of the payment key to the point of sale system. The merchant's payment system that transmits the payment key to the payment agent in a transaction request. The payment agent then verifies that the received payment key is the same as they received from the mobile device, and that the authenticated communication session is still valid, and then approves the transaction.

### FIELD OF THE INVENTION

The present invention relates generally to electronic payment methods, and, more particularly, relates to the use of a mobile device at a point of sale to complete a payment transaction from a managed account, in a way that simplifies the payment processing and secures the transaction.

### BACKGROUND OF THE INVENTION

Cashless payments have been in use for a long time, and have evolved from bank drafts (checks) to credit card impression machines, electronic credit card readers, and to digital payments. More recently, communications and computing technology have merged to produce smartphones and other mobile devices which are essentially hand held computing devices. These devices have become ubiquitous and are used by many people more for non-communications applications than they are for communications. Most financial institutions have produced their own application program for various mobile device operating systems to allow their customers to access the customers' account information and perform certain transactions on their mobile devices. Because people carry their mobile device virtually everywhere, the idea to use the mobile device to make payments at point of sale locations has become popular, eliminating the need to also carry payment cards and cash.

To facilitate the use of a mobile device for point of sale payments, many mobile devices have been designed to have near field communication (NFC) capability, which is a very low power radio communication interface that resembles radio frequency identification (RFID) but allows two-way communication. There are a variety of specific implementations of NFC, some of which leverage other low power wireless communication technology such as WiFi and BlueTooth, and some that use a dedicated transceiver. NFC has been used for “contactless” payments where the user can place their mobile device proximate and point of sale reader, and the two devices will detect each other, and communication financial information to effect a purchase. Systems such as Apple Pay and Google Pay can use NFC to make payments this way. These systems link a payment instrument, such as a credit card, to the contactless payment technology for payment.

One issue that has hindered widespread adoption of these contactless point of sale payment technologies is security. Many people are concerned that their financial information may be captured and used by others fraudulently. Since a credit card account, for example, is not tied to a specific device, if a malicious person is able to acquire the credit card information, they can then potentially use it to make fraudulent purchases. This costs the retail industry very large amounts of money as credit card issuers will deny payment of fraudulent purchases. Further, it can cause unwanted anxiety in the card holder, if not also financial loss.

Therefore, a need exists to overcome the problems with the prior art as discussed above.

### SUMMARY OF THE INVENTION

In accordance with some embodiments of the inventive disclosure, there is provided a method for conducting wireless point of sale transactions which includes, at a mobile device running a payment application, connecting to an identity management server over a network in an authenticated communication session. The method further includes, during the authenticated communication session and in response to user input at the mobile device, generating a unique payment code at the mobile device, wherein the unique payment code is based at least in part on a unique identifier of the mobile device. Further during the authenticated communication session, the method includes transmitting the unique payment code from the mobile device to the identity management server, and, upon receiving the unique payment code from the mobile device, the identity management server associating the unique payment code with a payment account associated with the mobile device. The method further includes, subsequent to associating the unique payment code with the payment account and while the authenticated communication session is valid, the mobile device transferring the unique payment code to a point of sale device for a payment transaction, and the point of sale device transmitting the unique payment code and a transaction amount to a payment server that is associated with the identity management server. The method further includes the payment server determining the payment account based on the unique payment code, the payment server comparing the unique payment code with a stored payment code associated with the mobile device, and when the unique payment code matches the stored payment code the payment server determining a payment instrument to be used for payment of the transaction amount. The method further includes transmitting to the point of sale device a transaction identifier to be used in a settlement process for the payment transaction.

In accordance with a further feature, generating the unique payment code comprises creating a hash of a media access controller address of a local wireless networking transceiver of the mobile device.

In accordance with a further feature, generating the unique payment code comprises creating a cryptographic hash of an international mobile equipment identifier of the mobile device.

In accordance with a further feature, generating the unique payment code comprises further basing the unique payment code on a present time at which the unique payment code is generated by the mobile device.

In accordance with a further feature, transferring the unique payment code to the point of sale device comprises concatenating an encrypted time stamp to the unique payment code.

In accordance with a further feature, determining the payment instrument to be used for payment of the transaction amount comprises identifying a pre-paid payment instrument maintained by the payment server in association with the payment account.

In accordance with some embodiments of the inventive disclosure, there is provided a method for authenticating a payment transaction at a point of sale device, including establishing an authenticated communication session between a mobile device and a payment server in which the mobile device accesses a payment account managed by the payment server, including generating a token having a session identifier that is stored at the mobile device and transmitted by the mobile device to the payment server in every communication transmitted by the mobile device to the payment server while the authenticated communication session is valid. Then, during the authenticated communication session, the method further includes, in response to user input at the mobile device, generating a payment code at the mobile device, wherein the payment code is based at least in part on a unique identifier of the mobile device; transmitting the payment code from the mobile device to the payment server, wherein the payment server stores the payment code as a stored payment code in association with the payment account; subsequent to transmitting the payment code to the payment server, transferring the payment code to a point of sale device of a merchant; the point of sale device transmitting the payment code and a transaction amount to the payment server; the payment server comparing the payment code received from the point of sale device with the stored payment code; and when the payment code matches the stored payment code, the payment server initiating a payment to the merchant from a payment instrument associated with the payment account.

In accordance with a further feature, the unique identifier of the mobile device is a media access controller address of the mobile device.

In accordance with a further feature, the unique identifier of the mobile device is an international mobile equipment identifier of the mobile device.

In accordance with a further feature, generating the payment code at the mobile device is performed by further including the token have the session identifier in the payment code with the unique identifier of the mobile device.

In accordance with a further feature, generating the payment code at the mobile device is performed by further including a current location of the mobile device in the payment code.

In accordance with a further feature, generating the payment code at the mobile device is performed by further including a randomly generated digital word in the payment code, wherein the mobile device generates the randomly generated digital word.

In accordance with a further feature, initiating the payment to the merchant comprises comparing the transaction amount with a balance of a pre-paid payment instrument.

In accordance with a further feature, initiating the payment to the merchant comprises the payment server transmitting the transaction amount and a merchant identifier to data center of a financial institution associated with a payment instrument indicated in an account record associated with the payment account.

In accordance with a further feature, the method further includes transmitting a transaction approval message to a transaction server of the merchant.

In accordance with a further feature, transferring the payment code to the point of sale device comprises generating a graphical representation of the payment code and presenting the graphical representation on a graphical display of the mobile device, and optically scanning the graphical representation by the point of sale device.

In accordance with a further feature, transferring the payment code to the point of sale device comprises transmitting the payment code to the point of sale device using a near field communication transceiver of the mobile device.

Although the invention is illustrated and described herein as embodied in a payment system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 shows a system diagram of a mobile device creating a unique payment code to be used in conducting transactions, in accordance with some embodiments;

FIG. 2 shows mobile device generating a unique payment code and elements used in the generation of the code, in accordance with some embodiments;

FIG. 3 shows a point of sale system in which a mobile device completes a transaction using a unique payment code, in accordance with some embodiments;

FIG. 4 shows a process flow diagram for generating and using a unique payment code, in accordance with some embodiments;

FIG. 5 shows a process flow diagram for using a unique payment code, in accordance with some embodiments;

FIG. 6 shows a database system for maintaining user accounts that can be used and accessed by different devices, in accordance with some embodiments;

FIG. 7 shows a flow chart diagram of a method for generating a unique payment code, in accordance with some embodiments; and

FIG. 8 shows a flow chart diagram of a method of using a unique payment code at a point of sale system, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

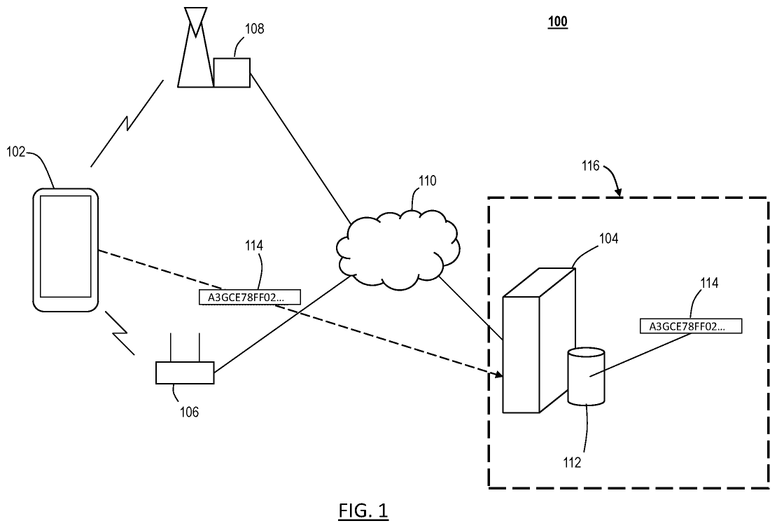

FIG. 1 shows a system diagram 100 of a mobile device 102 creating a unique payment code 114 to be used in conducting transactions, in accordance with some embodiments. As used here the term “mobile device” refers to a computing device that includes a wireless networking transceiver, such as, for example, a cellular phone device, a tablet computing device, or similar devices. Generally such devices can be handheld and are used while being held in the user's hands, unlike, for example, a laptop computer. In the example of FIG. 1, the mobile device 102 can be a cellular telephone device that includes a touch screen interface, a processing unit, memory including both random access memory and storage memory, a cellular transceiver, and a local wireless networking transceiver. Further, the mobile device 102 has an application program that includes instruction code that is configured to operate the mobile device 102 in accordance with the exemplary disclosure herein.

In order to address the problems associated with prior art, the mobile device 102 generates a unique code that is then provided to merchant's point of sale systems at the time of purchase. The point of sale system then forwards the code, along with transaction information, to a payment server to approve settlement. The generation of the code is performed while the mobile device is presently involved in an authenticated networked communication system with payment server or another server associated with the payment server. In order to establish the authenticated session, the user of the mobile device must input credentials into the mobile device, such in an interface of the application program that conducts the transaction. The payment server can verify not only that the code is a valid code for a payment account, but that it was provided to the point of sale system while the authenticated communication session is occurring, providing assurance that the transaction is legitimate. The payment server can decrypt the code to determine that information in the code is unique to the mobile device, and that the mobile device is currently in an authenticated session with the payment server or associated server. The payment server can then authorize the transaction and forward settlement information to the point of sale system for a settlement process between the merchant's financial institution and the purchaser's financial institution.

When the user of the mobile device 102 wants to pay for something at a point of sale, the user operates the mobile device 102 to establish an authenticated communication session with an identity management server 104 in the data center 116 of a payment agent. The identity management server 104 maintains an account with which the mobile device 102 is associated, for the purpose of wireless electronic payments by the mobile device 102. To access the identity management server 104, the mobile device can use, for example, a local wireless network 106, or a cellular data network 108 to connect over the internet 110 to the server 104. Further, the mobile device 102 must be running the application program, which facilitates communication with the server 104. When the mobile device 102 first contacts the server 104, the mobile device must log in to the user's account by presenting credentials (e.g. user name and password). Thereafter, assuming a successful login, the mobile device 102 and the server 104 will be in an authenticated communication session that can use secure communications such as hypertext transfer protocol secure (HTTPS). During the authenticated communication session, the user can operate the application program on the mobile device 102 to generate a code that is to be used for payments. That is, the application program, which generates the code, will only do so when there is an authenticated communication session with the server 104. To generate the code, the application program uses some unique identifier of the mobile device 102 as a basis for the code. For example, the media access controller (MAC) address of the local area or near field communication transceiver of the mobile device can be used. Another unique identifier that can be used is the international mobile equipment identifier (IMEI) of the mobile device 102. These are identifiers assigned to, and permanently programmed into, the hardware of the mobile device 102 by the manufacturer, and the manufacturer ensures that each mobile device has a unique IMEI and MAC address. In addition to the device identifier, the code can be further based on other information, such as, for example, the session identifier of the authenticated communication session, which can be recorded by the server 104 for later authentication. In addition, a time stamp, or even a random digital word can be used. All of this information, along with the unique device hardware identifier, can be concatenated in a prescribed format and then encrypted. The encryption can be a hash (e.g. a cryptographic hash), or performed using an encryption key that allows the server 104 to decrypt the information. The encrypted code can be formatted into a visual representation, such as a QR code. After generating the code 114, the code 114 is transmitted to the server. The server stores the code 114 in a database or data repository and associates the code with a payment account. This arrangement allows a payment account to be used by several devices, as each transaction will produce a new and unique code, which provides further security for the payment account when used by multiple devices. If the authenticated session between the payment server 104 (or associated server) and the mobile device 102 is ended, the code 114 becomes expired. Accordingly, to use the code 114 in a payment transaction at a point of sale, the authenticated session must persist through the point of sale transaction. After the code 114 has been generated, the mobile device 102 can format the code into a graphic image, such as a QR code, that can be displayed on the graphical display of the mobile device.

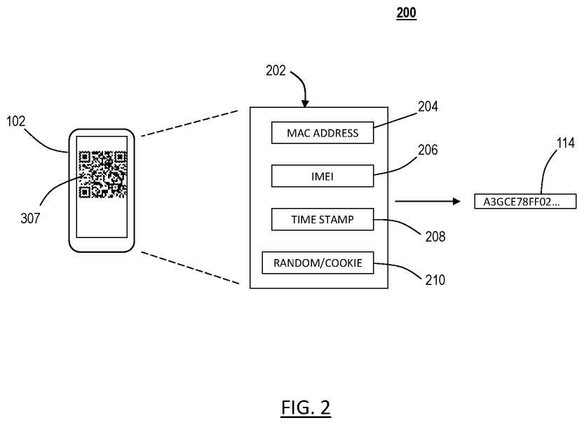

FIG. 2 shows mobile device 102 generating a unique payment code 114 and elements used in the generation of the code 114, in accordance with some embodiments. The payment application program instantiated on the mobile device 102 includes instruction code for generating the payment key 114. In order to do that, the mobile device 102 is operated by a user with the payment application program presenting an interface to the user on the mobile device's graphic display. Launching the application program can result in it automatically connecting to a data center including servers for managing payment accounts. The application program can maintain data on the mobile device 102 that includes, for example, a uniform resource locator (URL) of the data center that the application program can use to connect to the data center, and then present login credentials to establish an authenticated communication session. Once connected, the application program can provide an interface on the mobile device 102 that allows the user to select an option to create the code 114 for making a purchase. That is, the user operates the mobile device 102 interface to launch the application program, or bring it to the foreground it is it already running in the background, and selects a ‘purchase’ option to commence a purchase. In response to the user selecting the ‘purchase’ option, the mobile device creates the code 114. Again, this occurs while the mobile device is in an active authenticated communication session. Thus, if upon selecting the ‘purchase’ option the mobile device is not in an authenticated communication session with the server, the application program first transmits a connect request to the server, and requires the user to log in to their account in order to establish the authenticated session, and then the code 114 can be generated.

To generate the code 114, the mobile device 102 uses a block of information 202 that can include one or more “hard coded” unique identifiers. The identifiers are used in the hardware of the mobile device 102 and assigned by the manufacturer of the device, or the manufacturer of hardware used in building the mobile device 102. For example, the MAC address 204 of any of the low power wireless networking transceivers that are commonly provided in a mobile device, including a WiFi transceiver, a BlueTooth transceiver, a Near Field Communication transceiver, as examples. These transceivers all have unique identifiers that they transmit to other devices with which they communicate. Accordingly, a MAC address 204 can be used, and/or the IMEI 206.

Additional information can be used to generate the code 114, including a time stamp 208 which will coincide with the time in which the mobile device 102 was connected to the data center and which can be logged by the data center for verification of the code later. A random digital word 210 can be generated that is also used. Other data such as device location coordinates or the cookie/token received from the server upon establishing an authenticated session with the server can also be used. This data 202 can be concatenated and then encrypted by the mobile device 102, by the instruction code of the application program, and then transmitted during the authenticated session to the data center for storage and association with the user's account. Once the code is generated, it can be encrypted and transmitted to the server, and the encrypted code can be formatted into a graphical representation, such as a QR code 307 that can be scanned/read by a point of sale system. Alternatively, the code 114 can be transmitted wirelessly using a ‘contactless’ interface and NFC at the point of sale device. The code 114 can be produced, in some embodiments, by encrypting the block 202 by applying a cryptographic hash, or using a private key to the block 202.

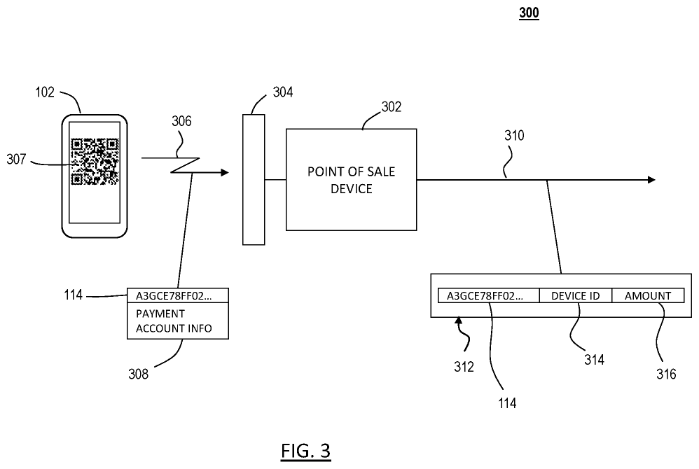

FIG. 3 shows a point of sale system 300 in which a mobile device 102 completes a transaction using a unique payment code 114, in accordance with some embodiments. The point of sale system 300 includes a point of sale device in which a person enters sales information, such as by selecting items, scanning price codes, etc., and presents a total to the purchaser. These point of sale devices 302 are often referred to as a “register,” referring to legacy mechanical cash registers. A reader 304 is coupled to the point of sale device and can be either a radio frequency reader or an optical reader, or both. Prior to making a purchase, the buyer/user operates the mobile device 102 to log into their payment account through the application program. Upon successfully logging in an authenticated session is established between the mobile device and the payment server/data center. Once the authenticated session is established, the user can select an option to make a purchase. In response to selecting that option, the application program can then commence generating a purchase code (e.g. 114). Once the price is displayed to the purchaser, the purchaser operates the mobile device 102 to present the payment code 114 and any additional information to the reader 304. The payment code 114 can be presented via a low power radio signal 306 that is received by the reader using, for example a near field communication (NFC) protocol, or it can be presented in an graphical image of a code, such as a QR code 307 that can be optically read by the reader 304. The radio signal 306 and optical code 307 both contain the payment code 114 and any additional information that may be necessary to conduct the transaction, such as a URL or other identifier that allows the point of sale device 302 to contact the appropriate payment agent.

Once the point of sale device 302 has acquired the information from the mobile device 102, the point of sale device 302 transmits a payment request 312 to the indicated payment agent. In some embodiments, the payment agent may be implicit as the payment agent may be the provider of the reader 304 and can set up the point of sale device to automatically direct any payment code received at the reader 304 to the payment agent. The payment request 312 includes the payment code 114, the transaction amount 316, and can include additional information including, for example, a device identifier 314, a merchant identifier, and any other information that may be necessary to verify and settle the transaction. The device identifier 314 can be obtained from the radio link 306 as it is included in the outgoing information from the mobile device 102, or the application program on the mobile device 102 can incorporate it in addition to the payment code 114 in either the radio signal 306 of the graphic code 307. If the mobile device 102 is fraudulently using an acquired payment code (e.g. one created on a different device), the IMEI or MAC address of the mobile device 102 will not match that used to create the payment code 114. The payment request 312 is sent 310 over a network to the payment agent for processing, and a response is then returned by the payment agent to the point of sale device for later settlement, or to indicate denial of payment. By requiring the mobile device 102 to remain in an authenticated session with the payment server throughout the process the transaction is secure and the payment server can have a high degree of confidence that the account holder is the one conducting the transaction, or at least certain enough that burden would be on the account holder to prove the transaction was fraudulent and not authorized by the account holder.

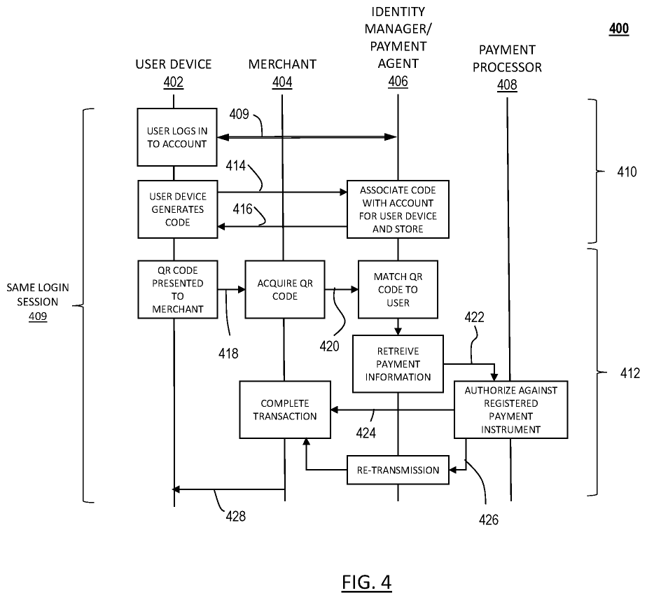

FIG. 4 shows a process flow diagram of a process 400 for generating and using a unique payment code during a payment transaction, in accordance with some embodiments. The process 400 assumes the payment agent and the financial institution responsible for payment settlement are separate. This allows the user to use the payment agent to make purchases, but the financial settlement is conducted between the merchant and the purchaser's financial institution. The process 400 involves the user's mobile device 402, the merchant 404, the identity manager 406, and the payment processor 408. The user's mobile device can be equivalent to mobile device 102, and the merchant 404 can be represented, for example, by a point of sale device and reader such as point of sale device 302 and reader 304. The identity manager 406 is a processing device such as a server and database/data store in a payment agent's data center. The payment processor 408 is the user's financial institution who has issued a payment instrument to the user. It will be understood by those skilled in the art that the merchant 404 refers to equipment operated by the merchant business, which can be a data center having one or more transaction servers through which transactions are processed between the merchant business and financial institutions.

The process in split into the set up portion 410 and the use portion 412. In the set up portion 410, the user's device 402 is used to establish an authenticated session 409 with the payment agent 406. As used here the term “payment agent” refers to the computing equipment (e.g. servers, databases, cloud services, etc.) operated by an entity that processes payments and remunerates funds to the entities that the account holder has bought from using the described processes. The device must provide credentials to the payment agent 406 in order for the session to be authenticated. Preferably the process uses two factor authentication. Further, when the user account is created (prior to commencing process 400), or accessed for the first time by the mobile device, the mobile device is registered with the payment agent 406 such that the payment agent has certain identification information of the device that is unique to the device, such as an IMEI or a MAC address. This information can be used to authenticate the device in establishing session 409, along with more conventional credentials such as username and password. In the process of establishing the authenticated session the payment agent 406 can transmit a cookie or token to the mobile device 402. This token is used by the application program by including it in every request transmitted to the payment agent 406 (or the data center in general), and is well known under present HTTP communication protocols.

Once the authenticated session 409 commences, the mobile device 402 generates a payment code (e.g. 114). This step is performed during the authenticated communication session with the identify manager 406, response to a user input indicated the user wishes to make a purchase. The user device 402 then sends the code in step 414 to the identify manager 406. The identity manager 406 then stores and associates the payment code with a payment account of the user. That is, it stores the code in a way that ties the code to the user's account. In step 416 the identity manager 406 can acknowledge and confirm reception of the payment code. That satisfies the set-up portion 410.

In the use portion 412, while the mobile device is still in the authenticated session, the user of the device 402 operates the device 402 to present the payment code to the point of sale device of the merchant 404 in step 418. This can be done using a near field radio link or by presentation of a graphical image of a QR code, for example, that is optically scanned by the point of sale device. The merchant's point of sale device acquires the payment code, and in step 420 transmits the payment code, and payment information to the identity manager 406 or an equivalent entity in the payment agent's data center. The payment code can be decrypted by the identity manager 406 and the identity manager 406 can determine the payment account with which the payment code is associated. Upon identifying the payment account, the identity manager 406 can then verify that code received from the merchant matches the code received from the device 402, and (assuming the code received from the merchant matches the stored payment code at the payment agent) retrieve the user's payment information which identifies the payment instrument used by the user for payment transactions.

Then in step 422 the identity manager 406 transmits a request for payment to the payment processor 408 that includes the identity of the merchant, the merchant's point of sale device, and the transaction identifier. The payment processor can then verify that the user has sufficient funds or credit for the transaction and can then either approve or deny the transaction in step 424 by directly sending a transaction approval message (or denial message) to the merchant 404 to complete the transaction. If the transaction is approved, the purchaser can be issued a receipt, and the merchant retains the transaction approval information for settlement later. If the transaction is denied, the then merchant's point of sale device will indicate such, and an alternative payment can be used. In step 426, rather than the payment processor responding directly to the merchant in step 424, the payment processor 408 can instead forward the transaction approval/denial to the identify manager, which then forwards it to the merchant 404. In step 428 the merchant's point of sale device can issue a receipt or otherwise indicate that the transaction is complete. The receipt can be electronically transmitted, such as by an NFC connection, or by email or SMS message (the user's email or phone number can also be provided in step 418).

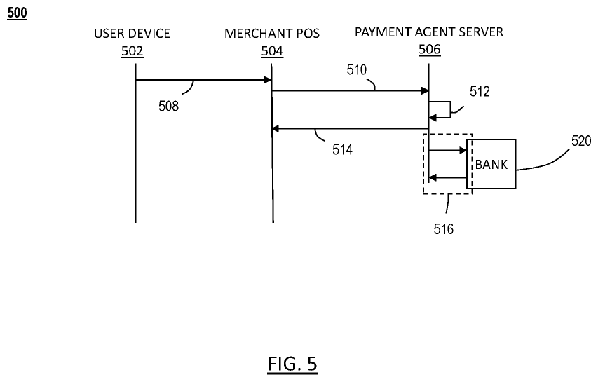

FIG. 5 shows a process flow diagram of a process 500 for using a unique payment code, in accordance with some embodiments. In process 500, rather than using a third party financial institution (e.g. payment processor 408) to approve transactions, the payment agent does it directly using a pre-paid payment instrument. The user adds funds to the pre-paid payment instrument, either directly or through the payment agent, and the payment agent uses those funds to directly satisfy purchases. The process 500 uses the same set-up portion 410 of process 400, and assumes here that has been performed. Thus, process 500 is an alternative use portion 412.

A user device (e.g. mobile device 102) is used at a merchant's point of sale device 504 to complete a purchase. After the price is presented, the user of the device 502 operates the device 502 to present the payment code (e.g. 114) to the point of sale device 504 in step 508. The payment code can be transmitted by a radio signal or by optical scanning of a graphic code image (e.g. a QR code). Upon receiving the payment code, the point of sale device transmits the payment code and purchase information in step 510 to the payment agent 506. The payment agent 506 uses the payment code to identify the account of the user. A pre-paid financial instrument is then charged for the purchase in step 512. The pre-paid instrument can be, for example, an account maintained by the payment agent on behalf of the account holder, and which will have a balance against which the payment agent charges the purchase amount. After deducting the purchase amount from the pre-paid payment instrument, the payment agent returns an approval in step 514 along with settlement information so that the merchant can settle the transaction through the merchant's payment processor. The pre-paid financial instrument can be managed by the payment agent, according to instructions set up by the account holder, to be replenished from a third party financial institution 520.

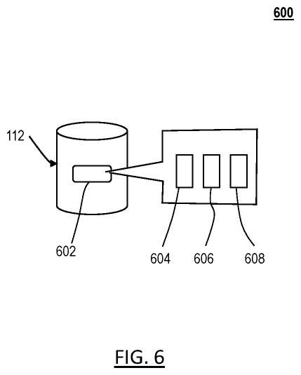

FIG. 6 shows a database system 600 for maintaining user accounts that can be used and accessed by different devices, in accordance with some embodiments. Since every device generates a unique payment code at the time of a transaction, multiple device can be registered to an account. Accordingly the database or data store 112 of the payment agent maintains information for an account record 602. The account record 602 can be accessed by multiple devices, thus each device has its own registration 604, 604, and 608. This provides a security benefit in that if one device is lost or stolen over systems that use a single payment code or key that is generated at the server side of the system and distributed to each device using the account. The use of unique payment codes generated at the time of the transaction by the device(s) is a substantial improvement over payment systems where, for example, one single code is used for the account and shared by all/any device used to access the account.

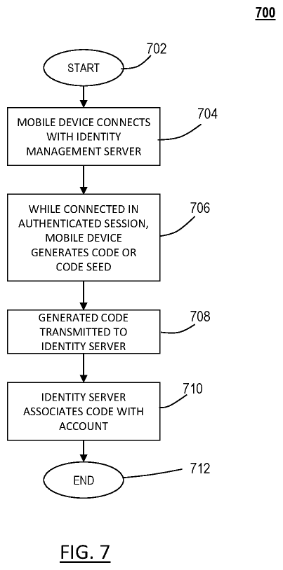

FIG. 7 shows a flow chart diagram of a method 700 for generating a unique payment code, in accordance with some embodiments. At the start 702 the mobile device is operating and has a copy of the payment application program instantiated and launched. The user of the device can launch the application program which then presents an interface to the user on the mobile device that allows the user to enter selections and information, and to view information, as is well known. In step 704 the user operates the mobile device through the application program to connect to the payment agent's identity management server, or an equivalent. This requires that the user present credentials to log into their account, and authenticate their identity. In some embodiments this may occur automatically, without requiring user input, where the credentials are stored in the device. In many cases the presentation of credentials is a second level of authentication as many users maintain their mobile device in a locked state, requiring some means of unlocking the device before it can be used, such as entering a code, using a biometric sensor, facial recognition, drawing a shape/gesture, and so on. If the device requires authentication to unlock, then it can be assumed that the user has unlocked the device if the application program has been launched.

In step 706, while connected to the payment agent system in the authenticated session, the user operates the mobile device to create a payment key. In response, the mobile device selects a unique identifier or other unique, immutable data of the mobile device, and creates the payment key by encrypting the data in a way that the payment agent can decrypt it, and which is resistant to others attempting to decrypt it. One way this can be done is using asymmetric encryption keys (e.g. public/private keys). After generating the payment key, the mobile device transmits the payment key to the payment agent in step 708 during the same authenticated session. If the session is broken, the payment agent will refuse to accept the payment key. Once the payment agent accepts the payment key, the payment agent associates the payment key with the user's account in step 710. By “associates” here it is meant that a copy of the payment key is stored the database/data store and linked to the account using, for example, metadata. Once the payment key is stored at the payment agent, the method 700 can end 712. Method 700 can also be used to generate a new payment key to replace a previously created payment key. While the identifier information may be the same, the other additional information (time stamp, location location/coordinates, etc.) will be different, resulting in a different key. Alternatively, or additionally, the encryption used to create the payment key can use current information (time stamp, location) to encrypt the identifier and other information.

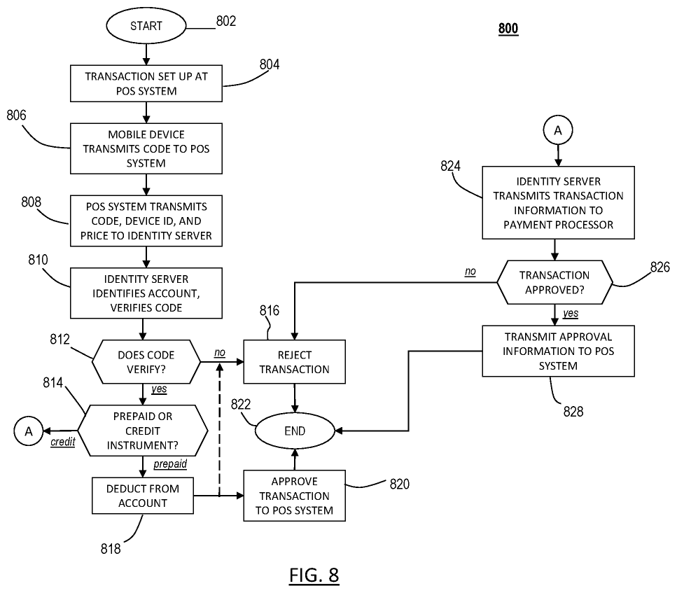

FIG. 8 shows a flow chart diagram of a method 800 of using a unique payment code at a point of sale system, in accordance with some embodiments. Method 800 is performed after method 700, and is the usage portion of flow of FIGS. 4-5 and is also performed while the mobile device is continuing an authenticated session with the identity server. Thus, at the start 802 method 700 has been performed, and the mobile device has a payment key stored in the mobile device. Further, the user of the mobile device is at a point of sale location and ready to complete a purchase. If the user's payment account uses a pre-paid payment instrument, then presumably the user has sufficiently funded the pre-paid payment instrument.

In step 804 the purchase information has been finalized at the point of sale device with the price of the purchase being presented to the user of the mobile device. In step 806 the user operates the mobile device to transmit or present the payment key to the point of sale device, using, for example, radio transmission or optical scanning of the code being presented on the display screen of the mobile device, allowing the point of sale device to acquire the payment key. In step 808 the point of sale device transmits the payment key and purchase information to the payment agent. IN step 810 the payment agent receives the payment key and purchase information, and uses the payment key to determine the account of the user. In step 812 the payment agent compares the received payment key with the payment key stored in association with the account for the mobile device. If the received payment key does not match the stored payment key, then the method 800 rejects the transaction in step 816 and the method 800 can end 822. If the purchase is rejected, then the payment agent will simply return a “declined” message to the point of sale device. Assuming the received payment key matches the stored payment key in step 812, then in step 814 the type of payment used is ascertained. Either a pre-paid payment instrument is used, or a credit/debit payment instrument of a third party financial institution is used. If a pre-paid payment instrument is used, the method 800 proceeds to step 818 in which the payment agent attempts to deduct the purchase price from the per-paid account. Assuming there are sufficient funds in the pre-paid account, the purchase can be approved in step 820 and settlement information is then returned to the point of sale device. Alternatively, as represented by the dashed line after step 818 to step 816, if there are not sufficient funds to cover the purchase, the transaction is denied.

When, in step 814, the payment account uses a third party financial institution, then from step 814 the method 800 proceeds to step 824 where the payment agent identifies the third party institution and transmits transaction information for the purchase to the third party financial institution. In step 826 the third party financial institution either approves of rejects the purchase/transaction. If the purchase is rejected then step 816 is followed, and if the purchase is approved step 828 is followed where the transaction authorization information is then transmitted to the point of sale device either by the third party financial institution or the payment agent, and the method ends 822.

An electronic payment system has been disclosed that uses a unique payment key based on at least one immutable data element of a mobile device in order to authorize electronic payments made using that mobile device exclusively. That is, the payment key will not result in an authorized transaction if used with any other device. The payment key is created during an authenticated session between the mobile device and the payment agent's data center. The user uses an application program on the mobile device to log into their account at the payment agent, and during that session the mobile device creates the payment key and transfers it to the payment agent for storage in association with the user's account. Thereafter, when the mobile device is used to pay for something at a point of sale, the mobile device facilitates transfer of the payment code to the point of sale device so that the point of sale device can transmit the payment code to the payment agent for approval of the transaction. Every device used by the user or those authorized to use the payment account each have their own unique payment code associated with the account.

The claims appended hereto are meant to cover all modifications and changes within the scope and spirit of the present invention.

1. A method for securing wireless point of sale transactions, comprising:
establishing an authenticated communication session, by a mobile device, with an identity management server, over a communication network;
responsive to establishing, and during the authenticated communication session and further responsive to user input at the mobile device, the mobile device generating a unique payment code, wherein the unique payment code is based at least in part on a unique identifier of the mobile device;
further during the authenticated communication session, the mobile device transmitting the unique payment code to the identity management server;
upon receiving the unique payment code from the mobile device, and during the authenticated communication session, the identity management server associating the unique payment code with a payment account associated with the mobile device;
subsequent to transmitting the unique payment code to the identity management server and while the authenticated communication session is valid, the mobile device transferring the unique payment code to a point of sale device for a payment transaction;
the point of sale device transmitting the unique payment code and a transaction amount to a payment server that is associated with the identity management server;
the payment server determining the payment account based on the unique payment code;
the payment server comparing the unique payment code with a stored payment code associated with the mobile device and further verifying that the authenticated communication session between the mobile device and the identity management server is still valid upon comparing the unique payment code with the stored payment code;
when the unique payment code matches the stored payment code the payment server, and responsive to the payment server confirming that the authenticated communication session is still valid, the payment server determining a payment instrument to be used for payment of the transaction amount; and
further responsive to the payment server confirming that the authenticated communication session is still valid, the payment server transmitting to the point of sale device a transaction identifier to be used in a settlement process for the payment transaction.

2. The method of claim 1, wherein generating the unique payment code comprises creating a hash of a media access controller address of a local wireless networking transceiver of the mobile device.

3. The method of claim 1, wherein generating the unique payment code comprises creating a cryptographic hash of an international mobile equipment identifier of the mobile device.

4. The method of claim 1, wherein generating the unique payment code comprises further basing the unique payment code on a present time at which the unique payment code is generated by the mobile device.

5. The method of claim 1, wherein transferring the unique payment code to the point of sale device comprises concatenating an encrypted time stamp to the unique payment code.

6. The method of claim 1, wherein determining the payment instrument to be used for payment of the transaction amount comprises identifying a pre-paid payment instrument maintained by the payment server in association with the payment account.

7. A method for authenticating a payment transaction at a point of sale device, comprising:
establishing an authenticated communication session between a mobile device and a payment server in which the mobile device accesses a payment account managed by the payment server, including generating a token having a session identifier that is stored at the mobile device and transmitted by the mobile device to the payment server by the mobile device to the payment server while the authenticated communication session is valid;
during the authenticated communication session:
in response to user input at the mobile device, generating a payment code at the mobile device, wherein the payment code is based at least in part on a unique identifier of the mobile device;
transmitting the payment code from the mobile device to the payment server, wherein the payment server stores the payment code as a stored payment code in association with the payment account;
subsequent to transmitting the payment code to the payment server, transferring the payment code to a point of sale device of a merchant;
the point of sale device transmitting the payment code and a transaction amount to the payment server;
the payment server comparing the payment code received from the point of sale device with the stored payment code and verifying that the authenticated communication session is presently valid; and
when the payment code matches the stored payment code and the authenticated communication session is still valid as determined by the verifying, the payment server initiating a payment to the merchant from a payment instrument associated with the payment account.

8. The method of claim 7, wherein the unique identifier of the mobile device is a media access controller address of the mobile device.

9. The method of claim 7, wherein the unique identifier of the mobile device is an international mobile equipment identifier of the mobile device.

10. The method of claim 7, wherein generating the payment code at the mobile device is performed by further including the token having the session identifier in the payment code with the unique identifier of the mobile device.

11. The method of claim 7, wherein generating the payment code at the mobile device is performed by further including a current location of the mobile device in the payment code.

12. The method of claim 7, wherein generating the payment code at the mobile device is performed by further including a randomly generated digital word in the payment code, wherein the mobile device generates the randomly generated digital word.

13. The method of claim 7, wherein initiating the payment to the merchant comprises comparing the transaction amount with a balance of a pre-paid payment instrument.

14. The method of claim 7, wherein initiating the payment to the merchant comprises the payment server transmitting the transaction amount and a merchant identifier to data center of a financial institution associated with a payment instrument indicated in an account record associated with the payment account.

15. The method of claim 7, further comprising transmitting a transaction approval message to a transaction server of the merchant.

16. The method of claim 7, wherein transferring the payment code to the point of sale device comprises generating a graphical representation of the payment code and presenting the graphical representation on a graphical display of the mobile device, and optically scanning the graphical representation by the point of sale device.

17. The method of claim 7, wherein transferring the payment code to the point of sale device comprises transmitting the payment code to the point of sale device using a near field communication transceiver of the mobile device.

18. A method for authenticating a payment transaction at a point of sale device, comprising:
establishing an authenticated communication session between a mobile device and a payment server in which the mobile device accesses a payment account managed by the payment server, including generating a token having a session identifier that is stored at the mobile device and transmitted by the mobile device to the payment server by the mobile device to the payment server while the authenticated communication session is valid;
during the authenticated communication session:
in response to user input at the mobile device, generating a payment code at the mobile device, wherein the payment code is based at least in part on a unique identifier of the mobile device;
transmitting the payment code from the mobile device to the payment server, wherein the payment server stores the payment code as a stored payment code in association with the payment account;
subsequent to transmitting the payment code to the payment server, transferring the payment code to a point of sale device of a merchant;
the point of sale device transmitting the payment code and a transaction amount to the payment server;
wherein at some time after establishing the authenticated communication session, the authenticated communication session is ended;
the payment server, responsive to receiving the payment code, comparing the payment code received from the point of sale device with the stored payment code and determining that the authenticated communication session is presently ended; and
responsive to the payment server determining that the authenticated communication session is presently ended, the payment server transmitting a rejection to the point of sale device.
